(19) United States
(12) Patent Application Publication
(10) Pub. No.: US 2011/0143322 A1
(43) Pub. Date: Jun. 16, 2011

(54) METHOD FOR WEIGHT MANAGEMENT

(75) Inventor: Peter Tjin Sjoe Kong Tsang, Eindhoven (NL)

(73) Assignee: KONINKLIJKE PHILIPS ELECTRONICS N.V., EINDHOVEN (NL)

(21) Appl. No.: 13/059,791

(22) PCT Filed: Aug. 17, 2009
(86) PCT No.: PCT/IB09/53609

§ 371 Date: Feb. 18, 2011

(30) Foreign Application Priority Data
Aug. 25, 2008 (EP) 08162882.8

(51) Int. Cl. G09B 19/00

(52) U.S. Cl. 434/127

(57) ABSTRACT

A method for managing the weight of a user is disclosed. The method comprises a) obtaining the energy expended by the user preferably in a day b) modeling the user's weight management and predicting the target weight that can be reached and the target time period required for achieving the predicted target weight based on the obtained energy expended in combination with the current weight of the user c) using the model and devising a weight management plan that the user has to pursue for a pre-determined time period d) using the devised weight management plan and coaching the user on a daily basis for the pre-determined time period and e) monitoring the progress at the end of the pre-determined time period and checking whether the user's weight is differing with respect to the weight that is to be achieved based on where the user is currently in the target time period and if so repeating step a, step b, step c and step d.

### FIELD OF THE INVENTION

The present subject matter relates to a method for managing the weight of a user.

### BACKGROUND OF THE INVENTION

U.S. Pat. No. 5,839,901 discloses an integrated system of collecting data and reporting results, enabling an understanding of weight control and weight loss. In an embodiment, the solution enables an individual to record estimates of weight, food calories and exercise calories to construct his/her own weight loss database. A graphical representation of the data enables the individual to detect body water shifts, weight plateauing and resting metabolic rate changes so as to enable the user to know the reasons why the individual is losing or not losing weight.

The solution disclosed in U.S. Pat. No. 5,839,901 is based on starving or burning of calories by additional physical activity. This solution generally does not give a complete overview of the weight management process. The solution generally does not guide the user towards the end goal of achieving the target weight. The disclosed solution may be suited for short term, but may fail over the long term.

Hence, it would be advantageous to have an improved weight management method that can help the user in managing his/her weight.

### SUMMARY OF THE INVENTION

Accordingly, the present subject matter preferably seeks to mitigate, alleviate or eliminate one or more of the above mentioned disadvantages singly or in combination. In particular, it may be seen as an object of the present subject matter to provide an improved weight management method.

This object and several other objects are obtained in a first aspect of the present subject matter by providing a weight management method, the method comprising:

a) obtaining the energy expended by the user preferably in a day;

b) modeling the user's weight management and predicting the target weight that can be reached and the target time period required for achieving the predicted target weight based on the obtained energy expended in combination with the current weight of the user;

c) using the model and devising a weight management plan that the user has to pursue for a pre-determined time period;

d) using the devised weight management plan and coaching the user on a daily basis for the pre-determined time period; and

e) monitoring the progress at the end of the pre-determined time period and checking whether the user's weight is differing with respect to the weight that is to be achieved based on where the user is currently in the target time period and if so repeating step a, step b, step c and step d.

It may not be practical to measure food intake. This requires caloric data of a wide range of foods and the user has to constantly input the amount of caloric food consumed. This can be laborious and impractical. Hence, energy expended is measured for example with an activity monitor and with the data provided by a weigh scale the daily calories needed and the metabolic rate is estimated using a model.

A target weight that can be reached is predicted along with the target time period required for achieving the predicted target weight using suitable software. It is possible to check whether the target weight set is realistic or not to achieve based on the user's input data. If the weight loss target is over ambitious it can be avoided because it can only lead to disappointment and it may not be healthy. On the other hand, if the weight loss target is realistic, then the disclosed method can show a default path and can allow the user to make small adjustments.

A weight management plan can be devised and the user can be constantly monitored and coached to achieve the predicted target weight. The user can be guided through the trajectory with a schedule. By looking at the trends over a longer period the model can be fine tuned and the model and the progress along the planned trajectory constantly updated. The disclosed method can adapt the weight management plan to the user's life style.

The progress (e.g. along the planned trajectory) can be constantly monitored to check whether the user is ON/OFF track in achieving the predicted target weight. In case of deviation, the user's weight management can be re-modeled and the weight management can be suitably adjusted. Hence, the user can be guided (e.g. through the schedule) during the weight management. Further, depending on where the user is on the time line the constant updated measured parameters can help to fine tune the model and make subtle changes that in turn can help the user to achieve the predicted target weight.

There are studies available on calorie requirement for different ages (for both males and females). These are generally averages but can be a good indication as to what healthy normal people should consume. This also gives the calorie one must expend to balance the energy intake to remain constant in weight. Therefore from the data e.g. activity monitor data it is possible to determine the amount of calorie from the food intake the user expends and the difference can be converted into weight gain/loss. This allows action to be taken in food reduction and activity increase.

In an embodiment of the method, physiological parameters of the user are sensed using a plurality of sensors and the user's weight management is modeled based on the sensed physiological parameters in combination with current weight of the user.

If the weight management is performed by means of a singular sensor for example using a weigh scale or an activity monitor it may not give a complete picture of what is going on. Further the modeling and prediction may not be accurate. Hence, this embodiment uses the input of multiple sensors first to determine what the user's metabolic rates are, weight, and activity level and food intake (indirectly). The user's weight management is then modeled and a prediction is given for the weight level that can be reached within a given timeline and at a realistic pace.

The physiological parameters can be:

i. the user's basal metabolic rates
ii. the user's weight
iii. the user's physical activity level
iv. the user's food intake

The sensors can be (but not limited to)

i. heart rate sensor
ii. activity monitor
iii. weigh scale
iv. fat calipers
v. pulse oximeter
vi. blood pressure meter

Based on the sensed physiological parameters the user's weight management can be modeled. As an illustrative example, the user's weight management can be modeled using the system disclosed in WO2007/072395. Although the weight prediction is similar to the one disclosed in WO2007/072395, the coaching disclosed here has to also deal with imparting discipline in eating the right foods during each phase of the diet. Therefore, the system can have additional inputs which the model disclosed in WO2007/072395 does not have such as data from fat caliper because weight can be gained over the course through muscle gain and it should not be seen as fat.

The model can basically work on the principle that Net energy=energy intake−energy expended. The energy expended is dependant on activity which in turn is dependant on the user's physiology (this is dynamic because the fitness levels changes and thus metabolic rate). Therefore we measure as much as possible and adjust for these changes to fine tune it to the user. To start with, an initial default value for metabolic rate is taken and gradually refined over time. These default values are all available for given age and body type from published studies and can be a good starting point. As an illustrative example, there are also studies of body mass index in relation to body fat % using which the model can work out the body fat %.

It is also possible to design the model such that it is not dependant on the specific type of sensor so that with each new sensor the model need not be adjusted.

In a still further embodiment, the method comprises programming an eating pattern and a physical activity pattern for the pre-determined time period. The pre-determined time period for example can be a week. This is done in order to provide a sense of discipline and normality in the body clock.

In a still further embodiment, programming the eating pattern and the physical activity pattern comprises:
splitting the day into a plurality of time slots;
distributing the amount of daily required physical activity over the plurality of time slots; and
selecting the type of food to eat during each time slot.
   A clear pattern can be defined by splitting every day into time slots. The aim is to follow this to create a body rhythm which can bring in discipline.

In a still further embodiment, the plurality of time slots are the time slots during which the user can consume food and is preferably the following:
breakfast time slot
morning tea break time slot
lunch break time slot
coffee break time slot
snacks break time slot
dinner break time slot
evening tea break time slot

The day can be split into various time slots during which the user can eat. As an illustrative example, time slots can be
breakfast time slot: 6:00 A.M-8:00 A.M, the interval being around 2:00 hours
morning tea break time slot: 9:30 A.M-10:30 A.M, the interval being around 1:00 hour
lunch break time slot:12:00 P.M-1:30 P.M, the interval being around 1:30 hours
coffee break time slot:3:00 P.M-3:45 P.M, the interval being around 0:45 hours
snacks break time slot: 4:30-5:00 P.M, the interval being around 0:30 hours
dinner break time slot: 7:00-8:30 P.M, the interval being around 1:30 hours
evening tea break time slot: 9:00-9:30 P.M, the interval being around 0:30 hours.

The idea here is to follow the defined eating pattern to create a body rhythm which can bring in discipline. High fat foods can be slowly weaned off. Mealtimes and snack breaks can be slowly instilled into the body rhythm so that constant hunger is gradually reduced. Advice can be given on the food types suited to the needs of the user e.g. based on the current status for e.g. rice, fish, pasta can be given and potatoes, cream can be avoided. It may be difficult to break the user's habit quickly and nor is it stimulating. Hence, in the disclosed method a disciplined eating pattern has been proposed which can be more effective. This way a soft landing is built in and throughout the trajectory of the program no constant details is given to the user unless requested, instead a simple feedback can be given when things are not on target and the activity can be subtly adjusted to increase or decrease.

In a still further embodiment, coaching the user for the pre-determined time period comprises:

i) notifying the user on daily physical activity schedule

ii) notifying the user daily on the quantity of the daily required physical activity completed and the quantity of the daily required physical activity that needs to be completed

iii) notifying the user on daily food intake schedule

iv) advising the food type and the amount of food to eat during each time slot.

Advice can be given as to the food type's best suited to the needs of the user at each phase of their trajectory. Coaching basically involves monitoring how much of the daily physical activity dose has been completed and secondly to tell the user when to eat and what type of food to eat.

As an illustrative example, in the morning at 6:00 a.m. a signal indicates the user that is it breakfast time and advises the user on the food that he can have for the breakfast e.g. 4 slices of bread, diet butter, glass of fruit juice and cup of tea or coffee. The advised food can be consumed by the user during 6:00 a.m to 8:00 a.m.

At around 9:30 a.m. a signal is generated that indicates to the user that it is coffee/tea break and the user is advised to have cup of coffee or tea during 9:30 a.m to 10:30 a.m. At the same time, the user is signaled that the daily physical activity required for the day is around 1000 calories and only 150 calories has been completed. This can motivate the user to walk or carry out some physical activity.

At around 12:00 p.m a signal is generated that indicates to the user that it is lunch time and the user is advised to have bowl of vegetable soup, portion of red meat, fresh vegetables, yoghurt and 4 slices of bread during 12:00 p.m to 1:30 p.m.

At around 3:00 p.m. a signal is generated that indicates to the user that it is coffee time and the user is advised to have 2 cups of coffee or tea during 3:00 to 3:45 p.m.

At around 4:30 p.m a signal is generated that indicates to the user that it is snacks time and the user is advised to have 5 biscuits during 4:30 to 5:00 p.m. Physical activity level that is required for the day and the physical activity level that needs to be completed are also indicated so that the user can walk or carry out some physical activity to complete the required dose.

At around 7:00 p.m a signal is generated that indicates to the user that it is dinner time and the user is advised to have bowl of corn soup, portion of meat, fish, fresh vegetables, yoghurt and 5 slices of bread during 7:00 p.m to 8:30 p.m.

At around 9:00 p.m signal is generated that indicates to the user that it is tea break and the user is advised to have cup of tea.

The disclosed method can inculcate the following:

i. discipline training

ii. eating the right food

iii. physical movement

to successfully manage the user's weight management. The above mentioned factors can be addressed simultaneously because they influence each other. The user can be continuously given coaching on the physical activity, the right type of food and the right type of eating pattern so that discipline is instilled.

In a still further embodiment, the time slots have wide intervals at the start of the weight management plan and as time progresses the intervals reduce until the predicted target weight is reached. This can ease the user into a regular eating pattern with defined meal and snack breaks. Further, a high physical activity can slow down the reduction of the intervals and vice-versa. Active people have different energy needs than less active people. These people require the right foods to satisfy their energy and physical requirements (minerals, hydration, proteins, vitamins etc).

In a still further embodiment, the method comprises providing feedback to the user on the progress of the weight management. Simple feedback can be given constantly to the person to show ON/OFF the weight management plan. Feedback on the detailed progress can be given if required to show the trends and the history. The feedback can inform the person about the progress and explain the changes involved. The feedback can motivate the person to follow the changes and reach the predicted target weight in the predicted time period.

In a second aspect of the present subject matter, a device for managing the weight of a user is disclosed. The device comprises:

a) means for obtaining the energy expended by the user preferably in a day;

b) means for modeling the user's weight management and predicting the target weight that can be reached and the target time period required for achieving the predicted target weight based on the obtained energy expended in combination with the current weight of the user;

c) means for using the model and devising a weight management plan that the user has to pursue for a pre-determined time period;

d) means for using the devised weight management plan and coaching the user on a daily basis for the pre-determined time period; and

e) means for monitoring the progress at the end of the pre-determined time period and checking whether the user's weight is differing with respect to the weight that is to be achieved based on where the user is currently in the target time period and if so activating the means a, b, c and d.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 schematically illustrates an exemplary weight management method according to an embodiment of the present subject matter;

FIG. 2 schematically illustrates an exemplary weight management plan according to an embodiment of the present subject matter;

FIG. 3 schematically illustrates programming an eating and physical activity pattern for a week according to an embodiment of the present subject matter;

FIGS. 4a-4b schematically illustrates exemplary time slots; and

FIG. 5 schematically illustrates an exemplary weight management device according to an embodiment of the present subject matter.

### DETAILED DESCRIPTION OF THE EMBODIMENTS

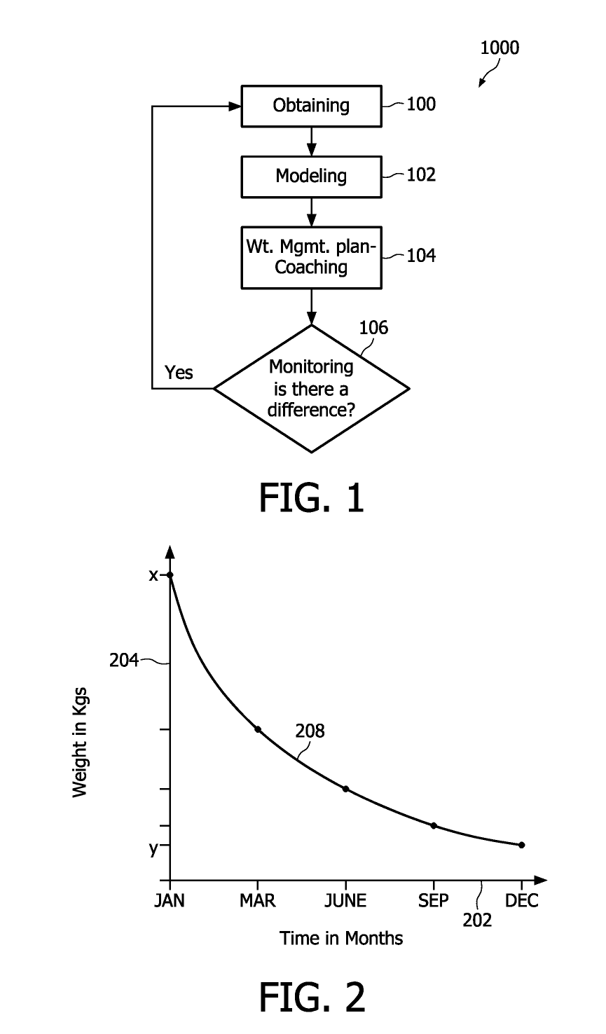

Referring now to FIG. 1, the method 1000 for managing the weight of the user comprises a step 100 of obtaining the energy expended by the user preferably in a day. The user can be provided with a portable device that can be worn by the user e.g. an activity monitor. The portable device can be a computer or a personal digital assistant. The portable device can be configured to measure the amount of energy expended by the user preferably in a day.

Physical activity can be measured by number of ways e.g. 3D accelerometers, step counters and heart rate monitors. These methods may give an indirect measurement of energy expenditure. Generally it is difficult to track what the daily food (energy) intake of a person is and hence it may be easier and more practical to measure the energy expended.

In step 102 the user's weight management is modeled based on the obtained energy expended in combination with the current weight of the user. As an illustrative example, the user's weight management can be modeled using the system disclosed in WO2007/072395. Alternately, any available modeling system can be used. The modeling software can be made available on the portable device. Alternately, the user can make use of any modeling software available on the Internet.

A target weight that can be reached can be predicted. The target time period required to achieve the predicted target weight can also be predicted. The prediction can be done using available software based on the energy expended in combination with the current weight of the user. The software for predicting the target weight can be made available on the portable device. Alternately, the user can make use of any software available on the Internet for predicting the target weight.

Referring now to FIG. 2, axis 202 represents the time period in months and axis 204 represents the weight in kilo grams. The initial weight of the person is x kilo grams in the month of January. The initial condition at the start of the weight management program can be as follows:
Age: 35 years

### Gender: Male

Height: 5 feet 7 inches
Weight: x kgs (e.g. 79 kgs)
Predicted target weight: y kgs (e.g. 69 kgs)
Program duration: 12 months
Activity level: 1900 cal
The modeled weight management predicts a target weight of y kilo grams achievable in a time period of 12 months ending December.

It is possible to check whether the target weight set is realistic or not to achieve based on the user's input data. If the weight loss target is over ambitious it can be avoided because it can only lead to disappointment and it may not be healthy. On the other hand, if the weight loss target is realistic, then the disclosed method can show a default path on the portable device and can allow the user to make small adjustments. As an illustrative example, if the user's current weight is 120 kgs and the portable device predicts a target weight of 100 kgs and the time period is 6 months, this may be unrealistic and the user may get de motivated to take part in the weight management program. On the other hand, a target weight of 70 kgs is realizable in a time period of 15 months and the user may feel it as a realizable target and can be motivated to take part in the weight management program.

In step 104, the user's weight management plan is devised. This is carried out by splitting the 12 months time period into small pre-determined time periods, programming an eating and physical activity pattern for the pre-determined time period and storing it on the portable device. As an illustrative example, the pre-determined time period can be a week. An eating pattern and a physical activity pattern can be programmed and stored on the portable device for one week.

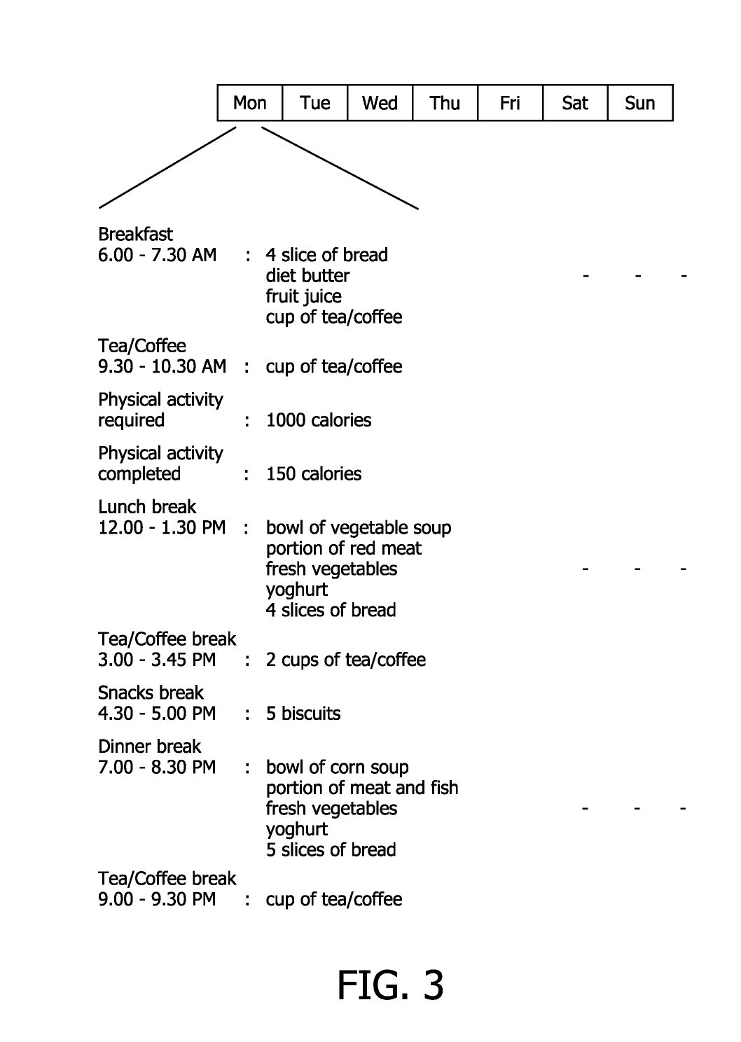

Referring now to FIG. 3, programming an eating and physical activity pattern for the week comprises:
splitting the day into a plurality of time slots;
distributing the amount of daily required physical activity over the plurality of time slots; and
selecting the type of food to eat during each time slot.

Once the programming is complete, the user can start his weight management program. The portable device can act as a monitor and a coach to guide and coach the user in achieving the predicted target weight.

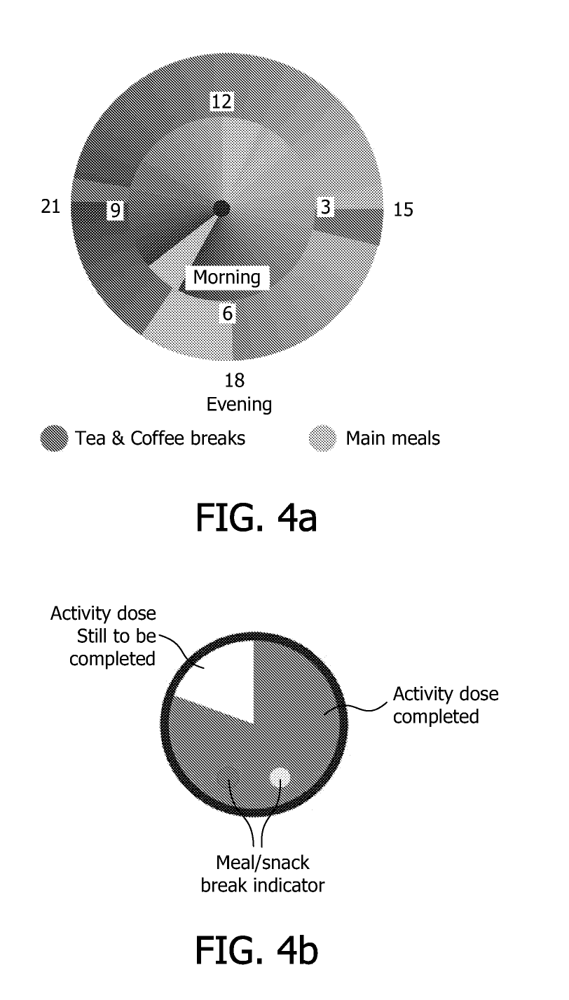

Referring now to FIG. 4a, the time slots can be
breakfast time slot: 6:00 A.M-8:00 A.M, the interval being around 2:00 hours
morning tea break time slot: 9:30 A.M-10:30 A.M, the interval being around 1:00 hour
lunch break time slot: 12:00 P.M-1:30 P.M, the interval being around 1:30 hours
coffee break time slot: 3:00 P.M-3:45 P.M, the interval being around 0:45 hours
snacks break time slot: 4:30-5:00 P.M, the interval being around 0:30 hours
dinner break time slot: 7:00-8:30 P.M, the interval being around 1:30 hours
evening tea break time slot: 9:00-9:30 P.M, the interval being around 0:30 hours.
   The aim here is to coach the person to follow the time slots and eat the right type of food. This can create a body rhythm which can bring in discipline.

FIG. 4b shows an example of snack break and mealtimes along with the physical activity dose spread over the whole day. For users who have no eating time zones they would generally eat irregularly or near continuously. The idea is to coach the user into eating time zones imposing borders and instilling discipline and thus adjusting the body clock into giving off signals when they should eat instead of having a constant hunger feeling. It takes time for the body to adjust to this lifestyle. The disclosed method is at first quite free in the time zones when the user can eat but slowly adjusts the time zones as they progress through the diet trajectory mapped out. The signal for them to eat or even a count down to when they can next can be conveyed by the portable device e.g. activity monitor or PC screen at work just like the RSI micro break. The key to weight management is discipline which means regimented lifestyle in a sense.

High fat foods can be slowly weaned off. Mealtimes and snack breaks can be slowly instilled into the body rhythm so that the constant hunger is gradually reduced. Advice can be given on the food types best suited to the needs of the user e.g. based on the current status rice, fish, pasta can be given and potatoes, cream can be discouraged (i.e. avoided). It may be difficult to break the user's habit quickly and nor is it stimulating. Hence, in the disclosed method a disciplined eating pattern has been proposed which can be more effective.

FIG. 4b also shows the monitoring of the required physical activity dose and food recommendation. The amount of physical activity completed can be monitored. Based on the amount of physical activity completed, the food intake can be appropriately adjusted by the user.

Generally it is difficult to track what the daily food (energy) intake of a person is and hence it may be easier and more practical to measure the energy expended. Comparing the average energy expenditure for a person of the same age, build and weight (slightly lesser weight) the target energy expenditure level can be set. Therefore the weight gain or loss can be made up either by eating less or moving more or a combination of both. To start with eating the right foods and moving more can yield good results.

Coaching can involve

i) notifying the user on daily physical activity schedule

ii) notifying the user daily on the quantity of the daily required physical activity completed and the quantity of the daily required physical activity that needs to be completed

iii) notifying the user on daily food intake schedule

iv) advising the food type and the amount of food to eat during each time slot.

The portable device which is worn by the user can notify the user regularly and coach the user in performing physical activity regularly and eating the right type of food thereby instilling discipline.

The coaching has to have a gentle start (fade in) in the trajectory 208 to avoid straining the user into giving up. But once the user crosses the threshold the activity level can be increased. The user can be coached to follow the trajectory 208 and achieve the predicted target weight of y kilo grams.

As an illustrative example, in the morning at 6:00 a.m. a signal indicates the user that is it breakfast time and advises the user on the food that the user can have for the breakfast e.g. 4 slices of bread, diet butter, fruit jam, glass of fruit juice and cup of tea or coffee. The advised food can be consumed by the user during 6:00 a.m to 8:00 a.m.

At around 9:30 a.m. a signal is generated that indicates to the user that it is coffee/tea break and the user is advised to have cup of coffee or tea during 9:30 a.m to 10:30 a.m. At the same time, the user is signaled that the daily physical activity required for the day is around 1000 calories and only 150 calories has been completed. This can motivate the user to walk or carry out some physical activity in order to complete the required dose of 1000 calories.

At around 12:00 p.m a signal is generated that indicates to the user that it is lunch time and the user is advised to have bowl of vegetable soup, portion of red meat, fresh vegetables, yoghurt and 4 slices of bread during 12:00 p.m to 1:30 p.m.

At around 3:00 p.m. a signal is generated that indicates to the user that it is coffee time and the user is advised to have 2 cups of coffee or tea anytime during 3:00 to 3:45 p.m.

At around 4:30 p.m a signal is generated that indicates to the user that it is snacks time and the user is advised to have 5 biscuits during 4:30 to 5:00 p.m. Physical activity level that is required for the day and the physical activity level that needs to be completed can also be indicated so that the user can walk or carry out some physical activity to complete the required dose of physical activity.

At around 7:00 p.m a signal is generated that indicates to the user that it is dinner time and the user is advised to have bowl of corn soup, portion of meat, fish, fresh vegetables, yoghurt and 5 slices of bread during 7:00 p.m to 8:30 p.m.

At around 9:00 p.m a signal is generated that indicates to the user that it is tea break and the user is advised to have 100 ml of tea.

The disclosed method can inculcate the following:

i. discipline training

ii. eating the right food

iii. physical movement

to successfully manage the user's weight management. The above mentioned factors can be addressed simultaneously because they influence each other. The user can be continuously given coaching on the physical activity, the right type of food and the right type of eating pattern so that discipline is instilled.

Further, the plurality of time slots can have wide intervals at the start of the user's weight management program and as time progresses the intervals can reduce until the predicted target weight level is reached. To adjust the user's eating habits (discipline) it is necessary to program the bioclock to set times. Eating main meals is much better and more fulfilling than uncontrolled snacking over the whole day. Users who are overweight often suffer from lack of discipline and it would be very difficult to impose a strict discipline from the onset of the diet. So the method gives them a wide window at the start of the trajectory and gradually narrows down the eating and snacking times so that the body can adjust to the times without causing too much disruption and discomfort to the user. If the start of the diet is too harsh the user would be discouraged and fallout rate would be high. The method also gives them information as to the types of snacks and foods that they can choose from and so guide them already to eating a more balanced diet e.g. a chocolate bar is equal to say 6 apples and so they know that while eating the chocolate would satisfy for 1 minute whereas the apples would let them snack six times.

The intervals can reduce based on the physical activity of the person. A high physical activity can slow down the reduction of the intervals and vice-versa. If the activity level of the person is sufficiently increased and that can be seen from the activity monitor and weighing scale then the user's energy requirements are relatively high so they would require more food intake than a less active person therefore it would be necessary for them to have a larger window for eating instead of asking them to stuff themselves full in the 3 mealtimes. Therefore with the activity level the eating time zones are adjusted to meet their needs.

In step 106 the progress is monitored at the end of the pre-determined time period i.e. after a week. A check is carried out to check whether the user's weight is differing with respect to the weight that is to be achieved in a week's time and if so the energy expended by the user preferably in a day is obtained, weight management is modeled and a target weight is predicted and a weight management plan is devised. The portable device is programmed with the eating and physical activity pattern and the user is regularly coached using the programmed eating and physical activity pattern.

If the weight management is performed by means of a singular sensor for example using a weigh scale or an activity monitor it may not give a complete picture of what is going on. Further the modeling and prediction may not be accurate. Hence, it is possible to use multiple sensors first to determine what the user's basal metabolic rates are, weight, activity and food intake (indirectly). The user's weight management can then be modeled and a prediction obtained for the weight level that can be reached within a given timeline and at a realistic pace.

The physiological parameters can be:

i. the user's stable metabolic rates

ii. the user's weight

iii. the user's physical activity level

iv. the user's food intake

The sensors can be (but not limited to)

i. heart rate sensor

ii. activity monitor

iii. weigh scale

iv. fat calipers

v. pulse oximeter

vi. blood pressure meter

Based on the sensed physiological parameters the user's weight management can be modeled. As an illustrative example, the user's weight management can be modeled using the system disclosed in WO2007/072395. Although the weight prediction is similar to the one disclosed in WO2007/072395, the coaching disclosed here has to also deal with imparting discipline in eating the right foods during each phase of the diet. Therefore, the system can have additional inputs which the model disclosed in WO2007/072395 does not have such as data from fat caliper because weight can be gained over the course through muscle gain and it should not be seen as fat.

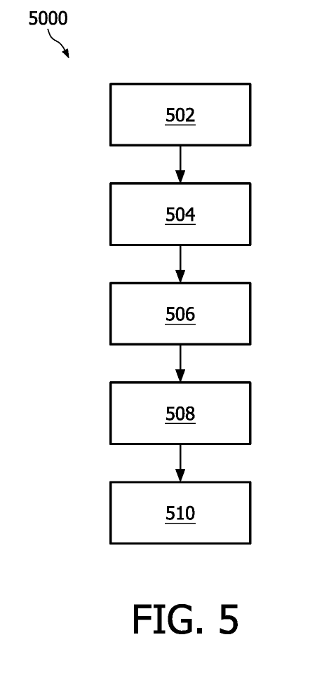

Referring now to FIG. 5, the device 5000 for managing the weight of a user comprises

a) means 502 for obtaining the energy expended by the user preferably in a day;

b) means 504 for modeling the user's weight management and predicting the target weight that can be reached and the target time period required for achieving the predicted target weight based on the obtained energy expended in combination with the current weight of the user;

c) means 506 for using the model and devising a weight management plan that the user has to pursue for a pre-determined time period;

d) means 508 for using the devised weight management plan and coaching the user on a daily basis for the pre-determined time period; and

e) means 510 for monitoring the progress at the end of the pre-determined time period and checking whether the user's weight is differing with respect to the weight that is to be achieved based on where the user is currently in the target time period and if so repeating step a, step b, step c and step d.

The device can be modular and built of portable sensors e.g. blood pressure meter, activity meter, fat calipers, heart rate monitor.

Alternately, the most basic device can be a weigh scale with an activity monitor. The activity monitor can have dual function:

i. measure how much of the daily activity has been completed
ii. coach and tell the person when to eat

Further, the device can comprise an easy to use interface to motivate and inform the person of progress and explain the changes involved in the weight management plan and the associated coaching.

More details about the weight management plan can be obtained from e.g. the computer but during daily use the portable device i.e. the activity monitor can simply just display O.K. or not O.K and more detail may be really not needed. The user does not need to be overfed with information when not required especially when everything is going according to plan. When measuring daily activities there could be bad days and good days but as the weight management is a long term plan these things should be averaged out so a weekly overview can be more useful and informative. Therefore a more intelligent and flexible way of interfacing with the user would be better instead of constant updates. Of course the activity is one bit of useful data for the user at the end of the day the other data that would need to be conveyed is the meal and snack break times these can also be done via the activity monitor or like the micro breaks for RSI displayed on the computer monitor.

In general, the prior art of designing sensors to sense the physiological parameters, modeling techniques, activity monitors to monitor the physical activity of the person, the feedback mechanism etc can be consulted to provide example of how to incorporate them into the disclosed method and apparatus. Such information is known to the art and is not set forth in detail.

In summary, a method for managing the weight of a person is disclosed. The method comprises a) obtaining the energy expended by the user preferably in a day b) modeling the user's weight management and predicting the target weight that can be reached and the target time period required for achieving the predicted target weight based on the obtained energy expended in combination with the current weight of the user c) using the model and devising a weight management plan that the user has to pursue for a pre-determined time period and d) using the devised weight management plan and coaching the user on a daily basis for the pre-determined time period and e) monitoring the progress at the end of the pre-determined time period and checking whether the user's weight is differing with respect to the weight that is to be achieved based on where the user is currently in the target time period and if so repeating step a, step b, step c and step d.

Although claims have been formulated in this application to particular combinations of features, it should be understood that the scope of the disclosure of the present subject matter also includes any novel features or any novel combination of features disclosed herein either explicitly or implicitly or any generalization thereof, whether or not is relates to the same subject matter as presently claimed in any claim and whether or not it mitigates any or all of the same technical problems as does the present subject matter.

Further, while the subject matter has been illustrated in detail in the drawings and foregoing description, such illustration and description are to be considered illustrative or exemplary and not restrictive; the subject matter is not limited to the disclosed embodiments. Other variations to the disclosed embodiments can be understood and effected by those skilled in the art of practicing the claimed subject matter, from a study of the drawings, the disclosure and the appended claims. As an example, fat callipers can be used to gauge muscle gain or fat lost as weight can be gained because fat has been replaced by muscle. Weight scale alone may not give the true picture. Hormonal changes due to menstruation can cause periodic fluctuations in fluid retention and thus weight. This can be taken into account in the modeling process. Additional sensors can be used to measure improvement in fitness. These may not be directly linked to weight management but the system can be expanded to include this since there could be detectable health improvements and this can be fed back to the person and can play a role in motivating the person in participating in the weight management plan.

Use of the verb “comprise” and its conjugates does not exclude the presence of elements other than those stated in a claim or in the description. Use of the indefinite article “a” or “an” preceding an element or step does not exclude the presence of a plurality of such elements or steps. A single unit may fulfill the functions of several items recited in the claims. The mere fact that certain measures are recited in mutually different dependent claims does not indicate that a combination of these measured cannot be used to advantage. The figures and description are to be regarded as illustrative only and do not limit the subject matter. Any reference sign in the claims should not be construed as limiting the scope.

1. A method (1000) for managing the weight of a user, the method comprising:
a) obtaining (100) the energy expended by the user preferably in a day;
b) modeling (102) the user's weight management and predicting the target weight that can be reached and the target time period required for achieving the predicted target weight based on the obtained energy expended in combination with the current weight of the user;
c) using the model (104) and devising a weight management plan that the user has to pursue for a pre-determined time period;
d) using the devised weight management plan and coaching the user on a daily basis for the pre-determined time period; and
e) monitoring (106) the progress at the end of the pre-determined time period and checking whether the user's weight is differing with respect to the weight that is to be achieved based on where the user is currently in the target time period and if so repeating step a, step b, step c and step d.

2. The method as claimed in claim 1, wherein physiological parameters of the user are sensed using a plurality of sensors and the user's weight management is modeled based on the sensed physiological parameters in combination with current weight of the user.

3. The method as claimed in claim 2, wherein devising the weight management plan comprises
programming an eating pattern and a physical activity pattern for the pre-determined time period.

4. The method as claimed in claim 3, wherein programming the eating pattern and the physical activity pattern comprises:
splitting the day into a plurality of time slots;
distributing the amount of daily required physical activity over the plurality of time slots; and
selecting the type of food to eat during each time slot.

5. The method as claimed in claim 4, wherein the plurality of time slots are the time slots during which the user can consume food and is preferably the following:
breakfast time slot
morning tea break time slot
lunch break time slot
coffee break time slot
snacks break time slot
dinner break time slot
evening tea break time slot

6. The method as claimed in claim 5, wherein coaching the user for the pre-determined time period comprises:
i) notifying the user on daily physical activity schedule
ii) notifying the user daily on the quantity of the daily required physical activity completed and the quantity of the daily required physical activity that needs to be completed
iii) notifying the user on daily food intake schedule
iv) advising the food type and the amount of food to eat during each time slot.

7. The method as claimed in claim 5, wherein the time slots have wide intervals at the start of the weight management plan and as time progresses the intervals reduce until the predicted target weight is reached.

8. The method as claimed in claim 1, further comprising providing feedback to the user on the progress of the weight management.

9. A computer program product comprising instructions for making a processor perform the method as claimed in claim 1.

10. A device for managing the weight of a user, the device comprising:
a) means (502) for obtaining the energy expended by the user preferably in a day;
b) means (504) for modeling the user's weight management and predicting the target weight that can be reached and the target time period required for achieving the predicted target weight based on the obtained energy expended in combination with the current weight of the user;
c) means (506) for using the model and devising a weight management plan that the user has to pursue for a pre-determined time period;
d) means (508) for using the devised weight management plan and coaching the user on a daily basis for the pre-determined time period; and
e) means (510) for monitoring the progress at the end of the pre-determined time period and checking whether the user's weight is differing with respect to the weight that is to be achieved based on where the user is currently in the target time period and if so activating the means a, b, c and d.
